(19) United States
(12) Patent Application Publication
(10) Pub. No.: US 2008/0164149 A1
(43) Pub. Date: Jul. 10, 2008

(54) Rapid gel electrophoresis system

(76) Inventor: Matthew R. Artz, Dunmore, PA (US)

Correspondence Address: ZALE Patent Law, 434 Lackawanna Ave., Suite 200, Scranton, PA, 18503-2053, US

(21) Appl. No.: 11/650,010

(22) Filed: Jan. 5, 2007

(51) Int. Cl. B01D 57/02

(52) U.S. Cl. 204/607

(57) ABSTRACT

A rapid electrophoresis system [1000] provides rapid separation of an unknown sample [1] into its component compounds. An unknown sample [1] which is to be identified is placed in an inert electrophoresis gel [1142] in a gel container [1140] in housing [1110]. The housing [1110] has electric plates [1151, 1153] straddling housing [1110]. A plurality of temperature sensors measure the temperature or chemical breakdown of gel [1142] in each track [1131, 1133, 1135, 1137] running the length of the gel container [1140]. The tracks [1131, 1133, 1135, 1137] are monitored, selectively cooled or heated by a thermal controller [1210] to bring them all to a pre-defined optimum temperature. The power across the plates is also adjusted by power controller [1210] to prevent heating and the gel [1142] from being chemically altered so that it maintains its functionality, while providing optimum performance. The temperature at each location and time, and the progression of the components could be standardized to compare current results to stored results of other components.

### BACKGROUND OF THE INVENTION

1. Field of the Invention

The present invention relates to a system for separating unknown materials into its components.

2. Discussion of Related Art

Prior art systems exist for separating samples into their various component compounds based upon their relative charge and the ease in which they pass through the gel. These samples are placed in a gel substrate and an electric field is applied over a reservoir holding the gel and sample. The electrophoresis gel does not chemically bind with the given sample and allows the sample to selectively migrate through it.

Component molecules with a higher charge have a greater electromagnetic force pulling them as compared with molecules having a lower charge. Therefore, the compounds travel through the gel a given distance in a given time period which generally indicates the charge of molecules of the various compounds (and the ease in which the molecules pass through the gel). This process of separating substances is known as gel electrophoresis.

This is a slow process and may take from 30 minutes to an hour to separate the unknown substance.

Attempts have been made to speed up this process. For example, the applied voltage producing the electric field has been increased, speeding up the process. The increased voltage causes heating of the gel and sample. If the temperature gets too high, it causes damage and denaturing of the sample.

Attempts have been made to use passive cooling by circulating air or water over the sample. This has some degree of success, but may not employ enough cooling.

Typically, several samples are run simultaneously in parallel tracks. The relative results are used in determining the sample type. Due to geometry of the electric field, the heating is uneven, and different tracks will heat differently and will separate the sample at different rates.

Currently, there is a need for a system which can rapidly and accurately separate an unknown substance into its components.

### SUMMARY OF THE INVENTION

One embodiment of the present invention is a rapid electrophoresis system [1000] for separating an unknown sample [1] in an electrophoresis gel [1142] comprising:
a. A power source [1190] having first pole and a second pole, for providing a voltage across its poles;
b. A housing [1110] filled with an ionic solution [1155] and a gel container [1140] holding said gel [1142] with said unknown sample [1] immersed within the ionic solution [1155], the housing [1110] having a front end, and a back end, at least one inlet [1250], and at least one outlet [1350];
c. a first electric plate [1151], and a second electric plate [1153], the first electric plate being positioned near the front end of housing [1110] with the second electric plate [1153] being positioned at the rear of the housing [1110], the first electric plate being coupled to the first pole of the power source [1190], and second electric plate [1153] being coupled to the second pole of the power source;
d. at least one sensor [1170] for sensing physical properties of at least one portion of the gel [1142];
e. a reservoir [1270] coupled to the housing for receiving the ionic solution [1155];
f. a pump [1300] coupled to the reservoir, and the housing [1110], the pump receiving ionic solution [1155] from the reservoir [1270] and circulating the ionic solution [1155] into the housing [1110], past the gel container [1140], out of housing [1110] and into the reservoir [1270];
g. a thermal controller [1230] coupled to the sensor [1170], the reservoir [1270], for determining if the ionic solution [1155] should cooled and operating the reservoir [1270] to interactively adjusting the temperature of the ionic solution [1155] accordingly.

It may also be embodied as a rapid electrophoresis system [1000] for separating an unknown sample [1] in an electrophoresis gel [1142] comprising:
a. A power source [1190] having a first pole and a second pole, for providing a power across its poles;
b. A housing [1110] filled with an ionic solution [1155], a gel container [1140] having a plurality of tracks [1131, 1133, 1135, 1137] each for holding said gel [1142] with said unknown sample [1], and a plurality of conduits [1141, 1143, 1145, 1147] in thermal communication with the tracks [1131, 1133, 1135, 1137] immersed within the ionic solution [1155], the housing [1110] having a front end, and a back end, at plurality of inlets [1251, 1253, 1255, 1257] each having a activatable valve [1251, 1253, 1255, 1257] capable of restricting flow through their respective inlets, and at least one outlet [1350];
c. a first electric plate [1151], and a second electric plate [1153], the first electric plate being positioned near the front end of housing [1110] with the second electric plate [1153] being positioned at the rear of the housing [1110], the first electric plate being coupled to the first pole of the power source [1190]; and the second electric plate being coupled to the second pole of the power source [1190].
d. at least one sensor [1170] in each track [1131, 1133, 1135, 1137] of gel container [1140] for sensing physical properties of at least one portion of the gel [1142] in each track;
e. a reservoir [1270] coupled to the housing for receiving the ionic solution [1155], and for cooling the ionic solution [1155] provided to it;
f. a pump [1300] coupled to the reservoir [1270], and the housing [1110], the pump receiving ionic solution [1155] from the reservoir [1270] and circulating the ionic solution [1155] into the housing [1110], past the gel container [1140], out of housing [1110] and into the reservoir [1270];
g. a thermal controller [1230] coupled to the sensor [1170], the reservoir [1270], the valves [1261-1267] for determining if the ionic solution [1155] should be cooled and operating the reservoir [1270] to interactively adjusting the temperature of the ionic solution [1155] and the valves [1261-1267] to adjust the amount of fluid flow through conduits [1143-1147] accordingly.

The present invention may also be embodied as a rapid electrophoresis system [1000] for separating an unknown sample [1] in an electrophoresis gel [1142] comprising:
a. a power source [1190] having at least two poles, for providing a voltage across its poles;
b. a housing [1110] filled with an ionic solution [1155], a gel container [1140] having a plurality of tracks [1131, 1133, 1135, 1137] each for holding said gel [1142] with said unknown sample [1], and a plurality of refrigeration units [1051, 1053, 1055, 1057] in thermal communication with the tracks [1131, 1133, 1135, 1137] immersed within the ionic solution [1155], the housing [1110] having a front end, and a back end, at least one inlet [1250], and at least one outlet [1350];
c. a first electric plate [1151], and a second electric plate [1153], the first electric plate being positioned near the front end of housing [1110] with the second electric plate [1153] being positioned at the rear of the housing [1110], the first electric plate being coupled to the first pole of the power source [1190];
d. at least one sensor [1170] in each track [1131, 1133, 1135, 1137] of gel container [1140] for sensing physical properties of at least one portion of the gel [1142] in each track;
e. a reservoir [1270] coupled to the housing for receiving the ionic solution [1155], and for heating or cooling the ionic fluid [1155] provided to it;
f. a pump [1300] coupled to the reservoir, and the housing 11110], the pump receiving ionic fluid [1155] from the reservoir [1270] and circulating the ionic fluid [1155] into the housing [1110], past the gel container [1140], out of housing [1110] and into the reservoir [1270];
g. a thermal controller [1230] coupled to the sensor [1170], the reservoir [1270], the valves [1261-1267] for determining if the ionic solution [1155] should be cooled and operating the refrigeration units [1051-1057] accordingly.

A rapid electrophoresis system [1000] for separating an unknown sample [1] in an electrophoresis gel [1142] comprising:
a. a power source [1190] having a first pole and second pole, for providing a power across its poles;
b. a housing [1110] filled with an ionic solution [1155], a gel container [1140] having a plurality of tracks [1131, 1133, 1135, 1137] each for holding said gel [1142] with said unknown sample [1], and a plurality of refrigeration units [1051, 1053, 1055, 1057] in thermal communication with the tracks [1131, 1133, 1135, 1137] immersed within the ionic solution [1155], the housing [1110] having a front end, and a back end, at least one inlets [1250], and at least one outlet [1350];
c. a first electric plate [1151], and a second electric plate [1153], the first electric plate being positioned near the front end of housing [1110] with the second electric plate [1153] being positioned at the rear of the housing [1110], the first electric plate being coupled to the first pole of the power source [1190]; and the second electric plate being coupled to the second pole.
d. at least one sensor [1170] in each track [1131, 1133, 1135, 1137] of gel container [1140] for sensing physical properties of at least one portion of the gel [1142] in each track;
e. a reservoir [1270] coupled to the housing for receiving the ionic solution [1155], and for cooling the ionic solution [1155] provided to it;
f. a pump [1300] coupled to the reservoir, and the housing [1110], the pump receiving ionic solution [1155] from the reservoir [1270] and circulating the ionic solution [1155] into the housing [1110], past the gel container [1140], out of housing [1110] and into the reservoir [1270];
g. a thermal controller [1230] coupled to the sensor [1170], the reservoir [1270], the valves [1261-1267] for determining if the ionic solution [1155] should be cooled and operating the refrigeration units [1051-1057] accordingly.

### OBJECTS OF THE INVENTION

It is another object of the present invention to provide a system which rapidly separates unknown substances into its components based upon electronic charge of each of the components.

It is another object of the present invention to provide a device which separates into its components more efficiently than prior art systems.

### BRIEF DESCRIPTION OF THE DRAWINGS

The advantages of the instant disclosure will become more apparent when read with the specification and the drawings, wherein:

FIG. 1 is a perspective overall view of a system according to one embodiment of the present invention.

FIG. 2 is a perspective overall view of a system according to a second embodiment of the present invention.

FIG. 3 is a perspective overall view of a system according to a third embodiment of the present invention.

### DETAILED DESCRIPTION OF THE INVENTION

Gel electrophoresis is a commonly-performed laboratory procedure used to analyze fragments of DNA—the genetic material found in cells. As biotechnology gains breadth and momentum as a critically important industry for our society, previously arcane procedures such as DNA analysis by gel electrophoresis are increasingly taught at the college and high school levels. One drawback to this technique, however, is the time needed to completely “run” a DNA sample on a “gel.” This constraint is due largely to the higher voltage and subsequent temperature increase observed when trying to run gels faster to fit into a set block of time for lab teaching. When attempting to run gels faster by applying higher voltage, the heat changes the viscosity of the gel, and adversely affects the DNA fragment profile, hindering analysis.

The present invention cools the gels used in electrophoresis gel systems with the aim of expediting gel electrophoresis by incorporating temperature sensing and control capabilities. The present invention employs an increased applied voltage to speed separation. As the power applied to the electric plates increases, the force exerted upon the charged compounds in the unknown substance increases thereby causing more rapid separation. However, increased power also causes heat to be released into the gel, thereby lowering its viscosity, further speeding separation. As the gel continues to heat, it comes to a point where either, or both, the gel and the sample are chemically altered and no longer perform as they did before the alteration. This may happen at a specific temperature, at a specific applied electric field, or at a combination of temperature and applied electric field depending upon the gel being used. The goal is to result in quicker sample separation while offsetting possible gel and sample degradation due to excessive heat.

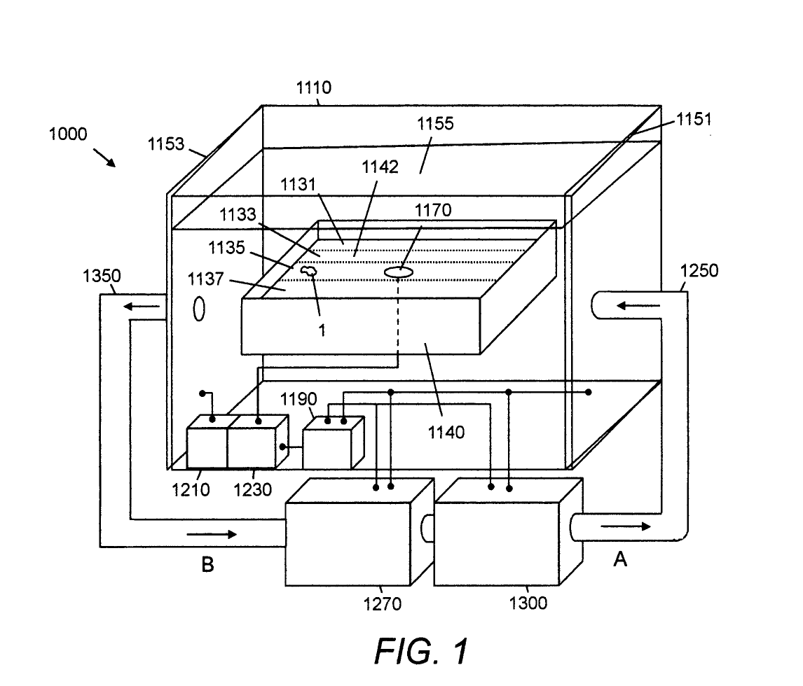

FIG. 1 is a perspective overall view of a system according to one embodiment of the present invention. A rapid gel electrophoresis system 1000 employs a housing 1110 which holds a gel container 1140 filled with electrophoresis gel 1142 and at least one sample 1 embedded in gel 1142 intended to be separated by gel electrophoresis. The sample 1 is placed in a track 1135 of gel container 1140. In this embodiment there are also other tracks 1131, 1133, 1137 to be used to separate other samples, or to be used to separate a known sample to be used as a reference.

An ionic solution 1155 is pumped from a reservoir 1270 by a pump 1300 through an inlet 1250 and into housing 1110. Ionic solution 1155 fills a good portion of housing 1110 submerging gel container 1140.

Ionic solution 1155 then passes out of outlet 1350 and back to reservoir 1270. Once in reservoir 1270, ionic solution 1155 is heated or cooled as necessary. Pump 1300 and reservoir 1270 receive power from a power source 1190.

At least one thermal sensor 1170 is dispersed within gel container 1140 and is connected to a thermal controller 1230.

Thermal controller 1230 has the ability to take information sensed by thermal sensors 1170 and determine if it is necessary to adjust the temperature of the ionic solution 1155, then activating cooling and/or heating elements in reservoir 1270 to properly adjust the temperature.

Power source 1190 provides electric power to be applied to a front electric plate 1151 and rear electric plate 1153 which straddle housing 1110. As a voltage is applied across these plates, an electric field is created across housing 1110, ionic solution 1155 and gel container 1140.

A power controller 1210 is connected to power source 1190, thermal sensors 1170 and/or the thermal adjustment apparatus of reservoir 1270. Power controller 1210 therefore may sense the temperatures in each of tracks 1131, 1133, 1135, 1137 and adjust the power provided to front plate 1151 and rear plate 1153.

In another embodiment, power controller 1210 causes thermal adjustment apparatus of reservoir 1270 to adjust the temperature of ionic solution 1155 without changing the applied electric power to plates 1151, 1153.

In still another embodiment, power controller 1210 adjusts power provided to plates 1151, 1153 while thermal controller 1230 also causes the temperature of the ionic solution 1155 to be adjusted.

Gel electrophoresis may be run on several samples, each in their own track. After a fixed period of time, the components separate into bands, each a different distance away from their starting point. The relative distance across different tracks provides information as to the nature of the sample being tested. This assumes that all tracks are under the same conditions. Therefore, it is important that all of the tracks 1131, 1133, 1135, 1137 are at the same temperature.

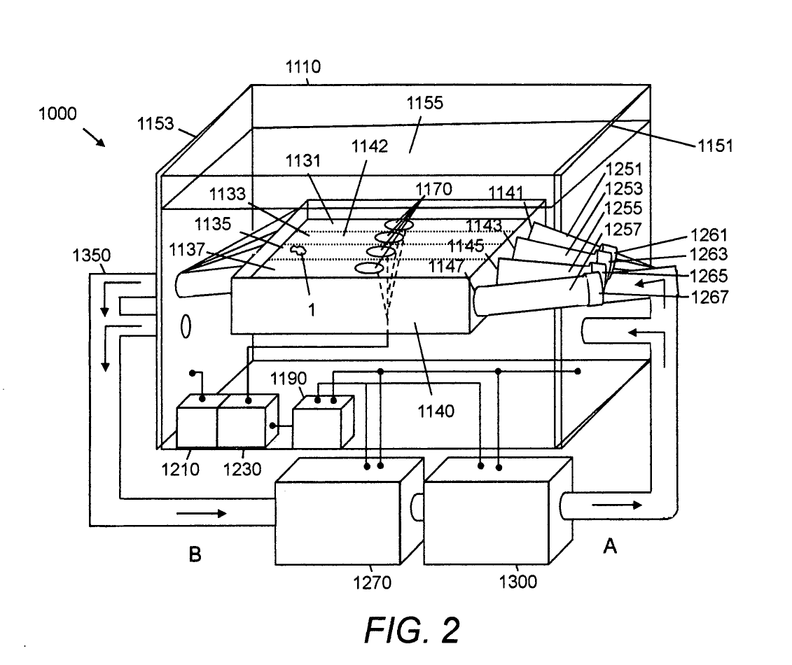

FIG. 2 shows another embodiment of the present invention. Each of the parts having the same numbers as FIG. 1 perform the same functions as described in connection with FIG. 1. A plurality of thermal sensors 1170 are dispersed in each of the tracks 1131, 1133, 1135, 1137 and all individually connected to thermal controller 1230. There are a plurality of inlets 1251, 1253, 1255, 1257 which each connect to a conduit 1141, 1143, 1145, 1147 running under each track 1131, 1133, 1135, 1137, respectively. Each inlet is opened and closed by a valve 1261, 1263, 1265, 1267, respectively. Each of the valves 1261-1267 is independently operated by thermal controller 1230. Therefore, thermal controller 1230 can monitor the temperature of each of the tracks 1131, 1133, 1135, 1137, and selectively operate valves 1261-1267 to supply the proper flow of coolant under each track 1131, 1133, 1135, 1137 to maintain the proper, uniform, optimum temperature for rapid separation of sample 1.

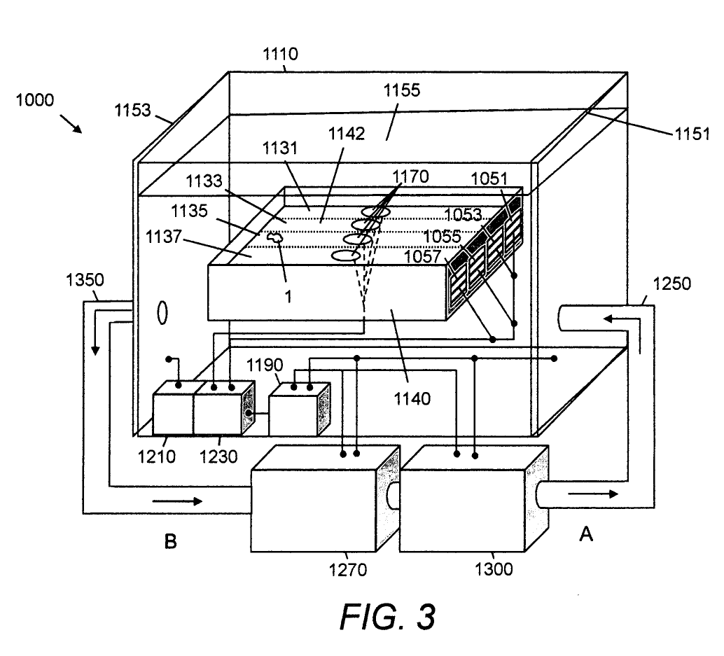

FIG. 3 shows still another embodiment of the present invention, each of the tracks 1131-1137 employs a refrigeration/heating unit running beneath the tracks which independently adjusts the temperature of each individual track 1131-1137 to keep them at the same optimum, uniform temperature.

The system may have multiple optical sensors in the tracks 1131, 1133, 1135, 1137 which monitor the locations of the various components over time as they migrate. One may also monitor and record the temperature and applied electric field over the same time period. This information may be provided to thermal controller 1230 and integrated over time. This may then be used as standardized absolute results and not be required to be used as results relative to a known sample.

Therefore, if there is a database of absolute results for various compounds and their progression data was standardized-for various gels, thermal controller 1230 may provide suggestions of other compounds which match the test characteristics.

Since other modifications and changes varied to fit particular operating requirements and environments will be apparent to those skilled in the art, the invention is not considered limited to the example chosen for the purposes of disclosure, and covers all changes and modifications which do not constitute departures from the true spirit and scope of this invention.

What is claimed is:

1. A rapid electrophoresis system [1000] for separating an unknown sample [1] in an electrophoresis gel [1142] comprising:
a. A power source [1190] having first pole and a second pole, for providing a power across its poles;
b. A housing [1110] filled with an ionic solution [1155] and a gel container [1140] holding said gel [1142] with said unknown sample [1] immersed within the ionic solution [1155], the housing [1110] having a front end, and a back end, at least one inlet [1250], and at least one outlet [1350];
c. a first electric plate [1151], and a second electric plate [1153], the first electric plate being positioned near the front end of housing [1110] with the second electric plate [1153] being positioned at the rear of the housing [1110], the first electric plate being coupled to the first pole of the power source [1190]; and second electric plate [1153] being coupled to the second pole of the power source.
d. at least one sensor [1170] for sensing physical properties of at least one portion of the gel [1142];
e. a reservoir [1270] coupled to the housing for receiving the ionic solution [1155];
f. a pump [1300] coupled to the reservoir, and the housing [1110], the pump receiving ionic solution [1155] from the reservoir [1270] and circulating the ionic solution [1155] into the housing [1110], past the gel container [1140], out of housing [1110] and into the reservoir [1270];
g. a thermal controller [1230] coupled to the sensor [1170], the reservoir [1270], for determining if the ionic solution [1155] should cooled and operating the reservoir [1270] to interactively adjusting the temperature of the ionic solution [1155] accordingly.

2. The rapid electrophoresis system [1000] of claim 1, further comprising:
a power controller [1210] coupled to the sensor [1170], the power source [1190] and the electric plates [1151, 1153] for interactively sensing the power applied to the plates [1151, 1153] and the physical properties of the gel [1142] and adjusting the power provided across the electric plates [1151, 1153] based upon the sensed physical properties of the gel to optimize separation of the unknown sample [1].

3. The rapid electrophoresis system of claim 2 wherein the sensor [1170] is a thermal sensor, the physical property of the gel [1142] being measured is temperature of the gel [1142], and the power controller [1210] adjusts the power being applied across the plates [1151, 1153] based upon measured temperature of the gel [1142].

4. The rapid electrophoresis system of claim 2 wherein the sensor [1170] is a thermal sensor the physical property of the gel [1142] being measured is temperature of the gel [1142], and the thermal controller [1230] adjusts the temperature of the ionic solution [1155] based upon measured temperature of the gel [1142].

5. The rapid electrophoresis system of claim 1 wherein the sensor [1170] is a chemical change sensor, the physical property of the gel [1142] measured is chemical change of the gel [1142], and the thermal controller [1230] adjusts the cooling provided to the gel [1142] based upon the degree of chemical change of the gel [1142].

6. The rapid electrophoresis system of claim 2 wherein the sensor [1170] is a chemical change sensor, the physical property of the gel [1142] measured is chemical change of the gel [1142], and the power controller [1210] adjusts the power being applied across the electric plates [1151, 1153] based upon the degree of chemical change of the gel.

7. A rapid electrophoresis system [1000] for separating an unknown sample [1] in an electrophoresis gel [1142] comprising:
a. A power source [1190] having a first pole and a second pole, for providing a power across its poles;
b. A housing [1110] filled with an ionic solution [1155], a gel container [1140] having a plurality of tracks [1131, 1133, 1135, 1137] each for holding said gel [1142] with said unknown sample [1], and a plurality of conduits [1141, 1143, 1145, 1147] in thermal communication with the tracks [1131, 1133, 1135, 1137] immersed within the ionic solution [1155], the housing [1110] having a front end, and a back end, at plurality of inlets [1251, 1253, 1255, 1257] each having a activatable valve [1251, 1253, 1255, 1257] capable of restricting flow through their respective inlets, and at least one outlet [1350];
c. a first electric plate [1151], and a second electric plate [1153], the first electric plate being positioned near the front end of housing [1110] with the second electric plate [1153] being positioned at the rear of the housing [1110], the first electric plate being coupled to the first pole of the power source [1190]; and the second electric plate being coupled to the second pole of the power source [1190].
d. at least one sensor [1170] in each track [1131, 1133, 1135, 1137] of gel container [1140] for sensing physical properties of at least one portion of the gel [1142] in each track;
e. a reservoir [1270] coupled to the housing for receiving the ionic solution [1155], and for cooling the ionic solution [1155] provided to it;
f. a pump [1300] coupled to the reservoir [1270], and the housing [1110], the pump receiving ionic solution [1155] from the reservoir [1270] and circulating the ionic solution [1155] into the housing [1110], past the gel container [1140], out of housing [1110] and into the reservoir [1270];
g. a thermal controller [1230] coupled to the sensor [1170], the reservoir [1270], the valves [1261-1267] for determining if the ionic solution [1155] should be cooled and operating the reservoir [1270] to interactively adjusting the temperature of the ionic solution [1155] and the valves [1261-1267] to adjust the amount of fluid flow through conduits [1143-1147] accordingly.

8. A rapid electrophoresis system [1000] of claim 7, further comprising:
a power controller [1210] coupled to the sensor [1170], the power source [1190] and the electric plates [1151, 1153] for interactively sensing the power applied to the plates [1151, 1153] and the physical properties of the gel [1142] and adjusting the power provided across the electric plates [1151, 1153] to optimize separation of the unknown sample [1].

9. The rapid electrophoresis system of claim 7 wherein the sensor [1170] is a thermal sensor, the physical property of the gel [1142] being measured is temperature of the gel [1142], and the power controller [1210] adjusts the power being applied across the plates [1151, 1153] based upon measured temperature of the gel [1142].

10. The rapid electrophoresis system of claim 8 wherein the sensor [1170] is a thermal sensor the physical property of the gel [1142] being measured is temperature of the gel [1142], and the thermal controller [1230] adjusts the temperature the amount of flow through each conduit [1141-1147] of the ionic solution [1155] based upon measured temperature of the gel [1142].

11. The rapid electrophoresis system of claim 7 wherein the sensor [1170] is a chemical change sensor, the physical property of the gel [1142] measured is chemical change of the gel [1142], and the thermal controller [1210] adjusts the cooling provided to the gel [1142] based upon the degree of chemical change of the gel [1142].

12. The rapid electrophoresis system of claim 7 wherein the sensor [1170] is a chemical change sensor, the physical property of the gel [1142] measured is chemical change of the gel [1142], and the power controller [1230] adjusts the power applied to the second electric plate based upon the degree of chemical change of the gel.

13. A rapid electrophoresis system [1000] for separating an unknown sample [1] in an electrophoresis gel [1142] comprising:
a. a power source [1190] having a first pole and second pole, for providing a power across its poles;
b. a housing [1110] filled with an ionic solution [1155], a gel container [1140] having a plurality of tracks [1131, 1133, 1135, 1137] each for holding said gel [1142] with said unknown sample [1], and a plurality of refrigeration units [1051, 1053, 1055, 1057] in thermal communication with the tracks [1131, 1133, 1135, 1137] immersed within the ionic solution [1155], the housing [1110] having a front end, and a back end, at least one inlets [1250], and at least one outlet [1350];
c. a first electric plate [1151], and a second electric plate [1153], the first electric plate being positioned near the front end of housing [1110] with the second electric plate [1153] being positioned at the rear of the housing [1110], the first electric plate being coupled to the first pole of the power source [1190]; and the second electric plate being coupled to the second pole.
d. at least one sensor [1170] in each track [1131, 1133, 1135, 1137] of gel container [1140] for sensing physical properties of at least one portion of the gel [1142] in each track;
e. a reservoir [1270] coupled to the housing for receiving the ionic solution [1155], and for cooling the ionic solution [1155] provided to it;
f. a pump [1300] coupled to the reservoir, and the housing [1110], the pump receiving ionic solution [1155] from the reservoir [1270] and circulating the ionic solution [1155] into the housing [1110], past the gel container [1140], out of housing [1110] and into the reservoir [1270];
g. a thermal controller [1230] coupled to the sensor [1170], the reservoir [1270], the valves [1261-1267] for determining if the ionic solution [1155] should be cooled and operating the refrigeration units [1051-1057] accordingly.

14. The rapid electrophoresis system [1000] of claim 13, further comprising:
A power controller [1210] coupled to the sensor [1170], the power source [1190] and the electric plates [1151, 1153] for interactively sensing the power applied to the plates [1151, 1153] and the physical properties of the gel [1142] and adjusting the power provided across the electric plates [1151, 1153] to optimize separation of the unknown sample [1].

15. The rapid electrophoresis system of claim 14 wherein the sensor [1170] is a thermal sensor, the physical property of the gel [1142] being measured is temperature of the gel [1142], and the power controller [1210] adjusts the power being applied across the plates [1151, 1153] based upon measured temperature of the gel [1142].

16. The rapid electrophoresis system of claim 14 wherein the sensor [1170] is a thermal sensor the physical property of the gel [1142] being measured is temperature of the gel [1142], and the thermal controller [1230] adjusts the cooling applied by the refrigeration units [1051-1057] based upon measured temperature of the gel [1142].

17. The rapid electrophoresis system of claim 7 wherein the sensor [1170] is a chemical change sensor, the physical property of the gel [1142] measured is chemical change of the gel [1142], and the thermal controller [1210] adjusts the cooling provided to the gel [1142] based upon the degree of chemical change of the gel [1142].

18. The rapid electrophoresis system of claim 7 wherein the sensor [1170] is a chemical change sensor, the physical property of the gel [1142] measured is chemical change of the gel [1142], and the power controller [1230] adjusts the power applied to the second electric plate based upon the degree of chemical change of the gel.
